(19) United States
(12) Patent Application Publication
(10) Pub. No.: US 2015/0332561 A1
(43) Pub. Date: Nov. 19, 2015

(54) POKER BASED CARD MECHANIC FOR A WAGERING GAME MACHINE

(71) Applicant: WMS Gaming Inc., Waukegan, IL (US)

(72) Inventor: ANTHONY J. BAERLOCHER, Henderson, NV (US)

(73) Assignee: WMS Gaming Inc., Waukegan, IL (US)

(21) Appl. No.: 14/278,369

(22) Filed: May 15, 2014

(51) Int. Cl. G07F 17/32

(52) U.S. Cl. CPC G07F 17/3293; G07F 17/3211; G07F 17/323

(57) ABSTRACT

A gaming system includes circuitry and methods for performing a video poker game, wherein the video poker game has a pay table specifying winning combination of poker hands, and comprises a tableau having a plurality of tableau stacks, where each tableau stack has zero or more hidden cards and an exposed top card. In response to a wager, players select exposed cards to form winning combinations of poker hands specified in the pay table until no more winning combinations may be formed from the exposed cards. When exposed cards are played, they are removed from play, replaced with hidden cards from the tableau stacks or stock pile (when available), and a win meter is incremented accordingly. Primary payout amounts may be specified for each of the indicated winning combinations in the pay table, as well as secondary payout amounts for secondary conditions which may occur during game play, including the number of played cards, cards contained in the set of played cards, and exposure/removal of the cards within each tableau stack and/or the entirety of the tableau.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods thereof, and more particularly, to a new type of card-based game mechanic for a wagering game machine.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

Poker has been a staple of card-based gaming combined with wagering since the 1800's. Since the invention of poker, the game has achieved widely attributed appeal, contributing to pop culture and phrases routinely used in language by those who may have no knowledge of history or origin of the particular expression. Likewise, single player cards games have been widely popular since the invention of playing cards. Various forms of these games, sometimes called “solitaire”, includes “Patience” and “Klondike” both using a tableau of cards which includes multiple stacks of face-down cards having one or more face-up cards atop each stack which must be used, moved, or otherwise manipulated prior to revealing the hidden card(s) beneath. A wide variety of entertaining and compelling games of chance suitable for a wagering machine may be formed from the combination of these two popular game mechanics.

### SUMMARY OF THE INVENTION

According to one aspect of the present invention, a gaming system is disclosed having one or more input devices and one or more display devices. The gaming system also has game-logic circuitry which includes one or more central processing units and one or more memory devices. The one or more memory devices store gaming-logic instructions executed by the one or more central processing units in response to an input indicative of a wager. In response to the wager, the gaming-logic instructions include displaying, via at least one of the one or more display devices, a tableau comprising a plurality of tableau stacks each having an exposed top card atop zero or more hidden cards. A determination is made as to whether any combination of all exposed cards matches a winning combination comprising at least one exposed card specified in a pay table. In response to a winning combination being exposed in the exposed cards, the gaming-logic acts to receive, via at least one of the one or more input devices, a selection of the exposed cards to be played to form the winning combination, remove the selected cards from play, and increment a win meter with a primary payout value corresponding to the winning combination. Lastly, the selected cards are replaced by selectively exposing cards from each of the corresponding plurality of tableau stacks or a card stock-pile comprising any remaining cards that are not a part of the plurality of tableau stacks.

According to another aspect of the invention, a computer-implemented method in a gaming system is disclosed. The gaming system includes game-logic circuitry including one or more central processing units and one or more memory devices. The computer-implemented method performs receiving, via at least one of one or more input devices, an input indicative of a wager. In response to the wager, the computer-implemented method displays, on at least one of one or more display devices, a tableau comprising a plurality of tableau stacks each having an exposed top card atop zero or more hidden cards. The computer-implemented method then determines, using the game-logic circuitry, whether any combination of all exposed cards matches a winning combination comprising at least one exposed card specified in a pay table. In response to a winning combination being exposed, the computer-implemented method receives, via at least one of the one or more input devices, a selection of the exposed cards to be played to form the winning combination, removes the selected cards from play, and increments a win meter with a primary payout value corresponding to the winning combination. The computer-implemented method then replaces the selected cards by selectively exposing cards from each of the corresponding plurality of tableau stacks or a card stock-pile comprising the remaining cards that are not part of the plurality of tableau stacks.

According to another aspect of the invention, a computer-implemented method in a gaming system having game-logic circuitry comprises receiving, via at least one of one or more input devices, an input indicative of a wager. In response, the game-logic circuitry displays, on at least one of one or more display devices, a plurality of tableau stacks each having an exposed card. One or more of the exposed cards are then selected to form a winning combination. The game-logic circuitry replaces the selected cards by selectively exposing cards from each of the corresponding plurality of tableau stacks or a card stock-pile comprising the remaining cards that are not a part of the plurality of tableau stacks. The game-logic circuitry provides an award when all the cards of a particular suit are replaced.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is an image of an exemplary basic-game screen of a wagering game displayed on a gaming machine, according to an embodiment of the present invention.

FIG. 4A is a flowchart for the game mechanics of a wagering game according to an embodiment of the present invention.

FIG. 4B is a flowchart for the game mechanics of a wagering game according to another embodiment of the present invention.

FIG. 5 is a flowchart for calculating payout of a wagering game according to an embodiment of the present invention.

FIG. 6-9 are images of an exemplary basic-game screen of a wagering game displayed on a gaming machine, according to an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

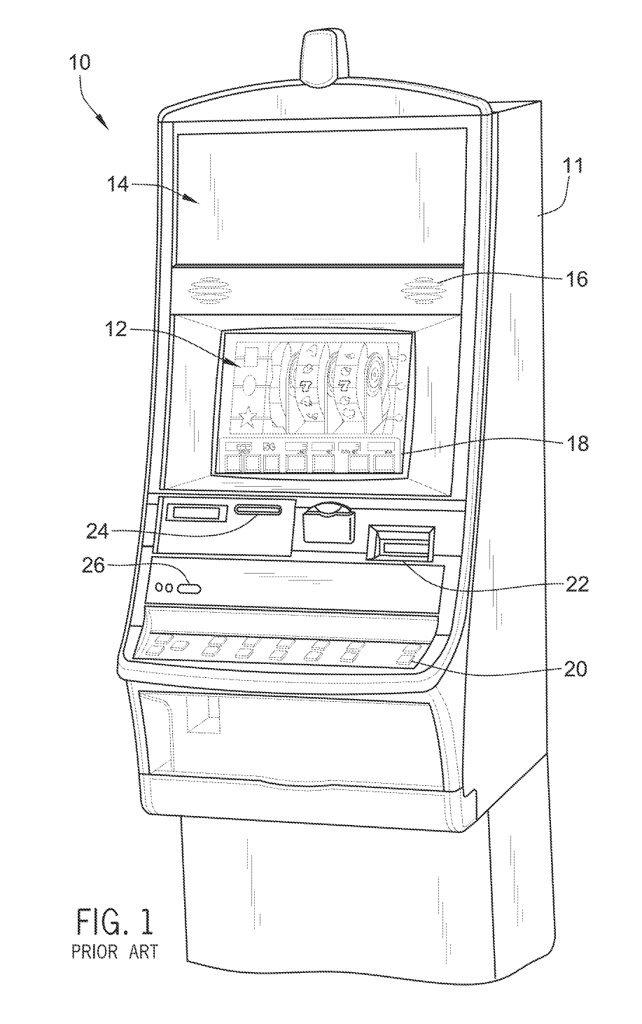

Referring to FIG. 1, there is shown a gaming machine 10 similar to those used in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in conducting wagering games, or may include non-dedicated devices, such as mobile phones, personal digital assistants, personal computers, etc. Exemplary types of gaming machines are disclosed in U.S. Pat. No. 6,517,433, U.S. Pat. No. 8,057,303, and U.S. Pat. No. 8,226,459, which are incorporated herein by reference in their entireties.

The gaming machine 10 illustrated in FIG. 1 comprises a cabinet 11 that may house various input devices, output devices, and input/output devices. By way of example, the gaming machine 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

Input devices, such as the touch screen 18, buttons 20, a mouse, a joystick, a gesture-sensing device, a voice-recognition device, and a virtual-input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a game-logic circuitry for processing. The electronic data signals are selected from a group consisting essentially of an electrical current, an electrical voltage, an electrical charge, an optical signal, an optical element, a magnetic signal, and a magnetic element.

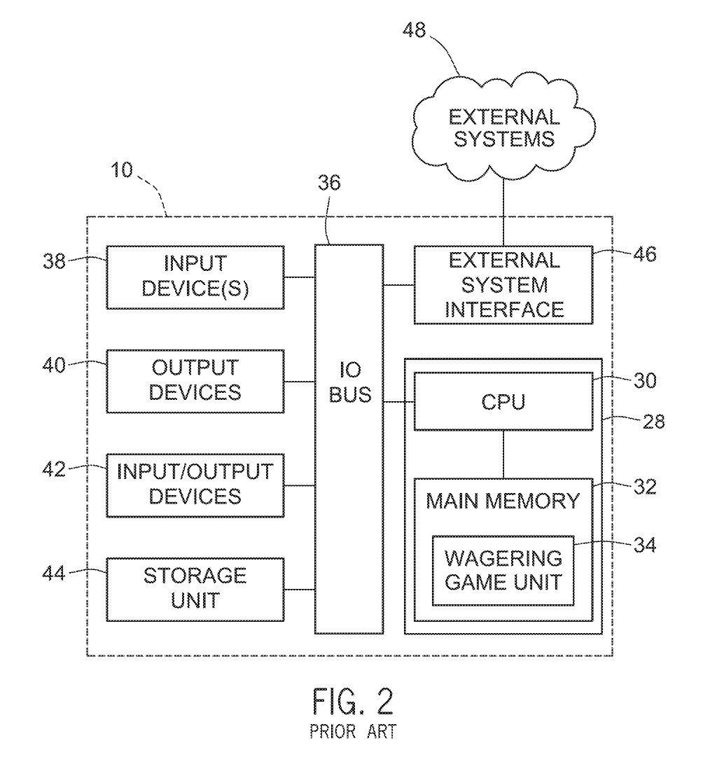

Turning now to FIG. 2, there is shown a block diagram of the gaming-machine architecture. The gaming machine 10 includes game-logic circuitry 28 having a central processing unit (CPU) 30 connected to a main memory 32. The CPU 30 may include any suitable processor(s), such as those made by Intel and AMD. By way of example, the CPU 30 may include a plurality of microprocessors including a master processor, a slave processor, and a secondary or parallel processor. Game-logic circuitry 28, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 28, and more specifically the CPU 30, comprises one or more controllers or processors and such one or more controllers or processors need not be disposed proximal to one another and may be located in different devices or in different locations. The game-logic circuitry 28, and more specifically the main memory 32, comprises one or more memory devices which need not be disposed proximal to one another and may be located in different devices or in different locations. The game-logic circuitry 28 is operable to execute all of the various gaming methods and other processes disclosed herein. The main memory 32 includes a wagering-game unit 34. In one embodiment, the wagering-game unit 34 may cause wagering games to be presented, such as video poker, video black jack, video slots, video lottery, etc., in whole or part.

The game-logic circuitry 28 is also connected to an input/output (I/O) bus 36, which can include any suitable bus technologies, such as an AGTL+frontside bus and a PCI backside bus. The I/O bus 36 is connected to various input devices 38, output devices 40, and input/output devices 42 such as those discussed above in connection with FIG. 1. The I/O bus 36 is also connected to a storage unit 44 and an external-system interface 46, which may be connected to external system(s) 48 (e.g., wagering-game networks).

The external system 48 includes, in various aspects, a gaming network, other gaming machines or terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external-system interface 46 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 48 such that the gaming machine 10 operates as a thin, thick, or intermediate client. The game-logic circuitry 28—whether located within (“thick client”), external to (“thin client”), or distributed both within and external to (“intermediate client”) the gaming machine 10—is utilized to provide a wagering game on the gaming machine 10. In general, the main memory 32 (comprising one or more memory devices) stores programming for an RNG, game-outcome logic, and game assets (e.g., art, sound, etc.). When a wagering-game instance is executed, the CPU 30 (comprising one or more processors or controllers) executes the RNG programming to generate one or more pseudo-random numbers. The pseudo-random numbers are utilized by the CPU 30 when executing the game-outcome logic to determine a resultant outcome for that instance of the wagering game. The resultant outcome is then presented to a player of the gaming machine 10 by accessing the associated game assets, required for the resultant outcome, from the main memory 32. The CPU 30 causes the game assets to be presented to the player as outputs from the gaming machine 10 (e.g., audio and video presentations).

The gaming machine 10 may include additional peripheral devices or more than one of each component shown in FIG. 2. Any component of the gaming-machine architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 12 or secondary display 14) through the display of information such as, but not limited to, text, graphics, static images, moving images, etc., or any combination thereof. In accord with the method of conducting the wagering game, the game-logic circuitry 28 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 28 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 30 causes the recording of a digital representation of the wager in one or more storage media (e.g., storage unit 44), the CPU 30, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU 30 (e.g., the wager in the present example). As another example, the CPU 30 further, in accord with the execution of the stored instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 28 to determine the outcome of the wagering-game instance. In at least some aspects, the game-logic circuitry is configured to determine an outcome of the wagering-game instance at least partially in response to the random parameter.

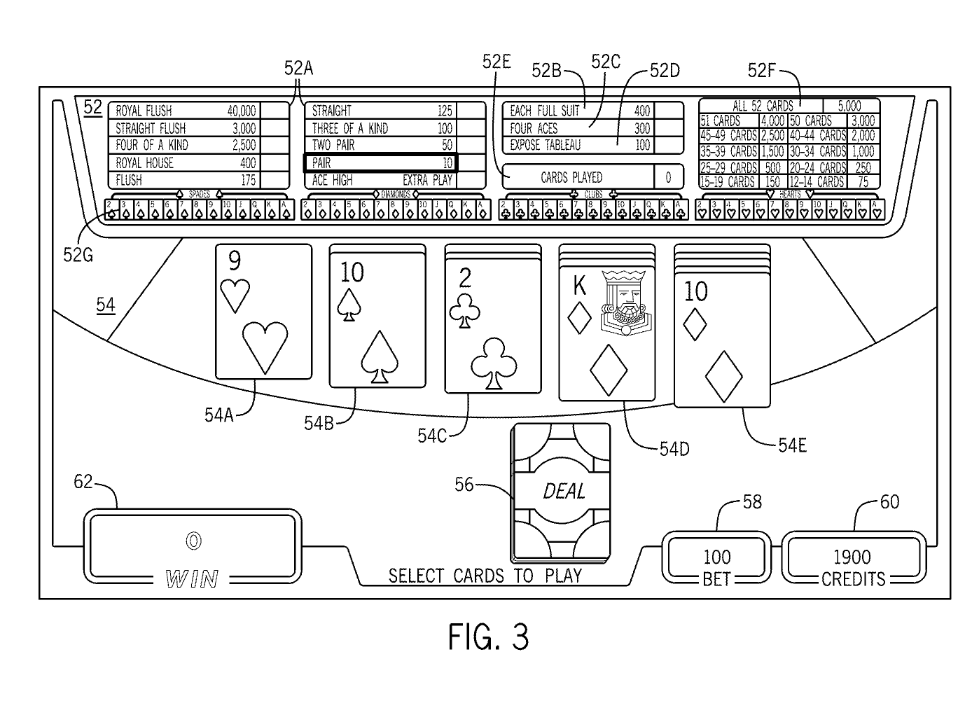

Referring now to FIG. 3, there is illustrated an image of a game screen 50 adapted to be displayed on the primary display area 12 or the secondary display area 14 in one embodiment of the invention. The game screen 50 displays a pay table 52, a tableau 54, a stock pile 56, a wager meter 58, a credit meter 60, and a win meter 62.

The pay table 52 specifies associated payouts for each individual achievement of a single winning combination, in addition to a set of secondary conditions or achievements which may result from one or more winning combinations. For example, in one embodiment the pay table 52 comprises winning combinations of ranked poker hands and a section for their associated primary payouts 52A, secondary payouts 52B-52D associated with wins for other, non-poker win conditions, a card meter 52E for tracking a number of cards during the game, associated payouts 52F for the number of cards played during the game, and a visual indication of representative cards 52G which have been played during game play, as shown in FIG. 3. In one embodiment, card meter 52E specifies a number of cards played (i.e., selected, submitted, and removed from play) during gameplay. In another embodiment, card meter 52E may specify the number of cards of a particular suit, used in a particular type of winning combination, or the number of face cards exposed during play. A skilled artisan will recognize that variation of any or all of these specifics may occur without departing from the spirit and scope of the present invention.

Other embodiments may display different winning combinations of cards and their associated payouts in pay table 52. For example, the winning combinations shown in primary payout section 52A may individually include any number of cards, subsets of other winning combinations of cards, or any other identifiable combination of the cards in play which constitute a winning combination of cards. Similarly, the secondary payouts 52B-52D may include a variety of other achievements or requirements for further payout. The accounting of the number of cards played during game play in card meter 52E and all associated payouts 52F may be arbitrarily assigned without departing from the spirit and scope of the present invention. A skilled artisan will recognize that variation of any or all of these specifics may occur without departing from the spirit and scope of the present invention.

The tableau 54 includes a plurality of tableau stacks 54A-54E which may have a different quantity of cards within each stack. According to one embodiment, tableau 54 initially comprises five tableau stacks 54A-54E, where tableau stack 54A comprises of a single face-up (exposed) card, tableau stack 54B has an exposed face-up card atop a single face-down card, tableau stack 54C has an exposed face-up card atop two face-down cards, tableau stack 54D has an exposed face-up card atop three face-down cards, and tableau stack 54E has an exposed face-up card atop four face-down cards. An artisan will recognize that tableau 54 may comprise an arbitrary number of tableau stacks, each stack having any number of face down cards associated therewith, without departing from the spirit and scope of the present invention.

While FIG. 3 shows five tableau stacks 54A-54E, with each stack having an increased number of hidden cards, tableau 54 may comprise seven tableau stacks having 4 hidden cards below the exposed card atop each tableau stack without altering the mechanics of the game play in any fashion. Thus, the number of tableau stacks and the number of cards in one or more of the tableau stacks can be varied to accommodate numerous game-design preferences, without departing from the spirit and scope of the present invention.

It is noted that the pay table 52 may also, or alternatively, be displayed on another display area separate from the tableau 54, for example, on the secondary display area 14, or not at all, and may be displayed, hidden, and revealed in any manner without departing from the spirit and scope of the present invention.

In one embodiment, the pay table 52 includes a payout amount for various winning combinations of cards arranged together to make different types of winning poker hands. As shown in the pay table 52, there are sets of winning combinations of cards in the primary payout section 52A, where a combination of cards making a straight flush pays three thousand credits, and a combination of only two identically ranked cards (i.e., a pair) pays ten credits. During game play, cards from the tableau stacks 54A-54E are played (i.e., selected, submitted, and removed from play) to construct winning combinations of ranked poker hands specified in the primary payout section 52A of the pay table 52. When a winning combination of cards is selected and submitted by a player, these winning combinations of cards cause respective fields of the pay table 52 to increment accordingly. For example, in response to a player selecting a straight flush from the set of exposed cards, the “STRAIGHT FLUSH” area of the primary payout section 52A may show “1”, “+1”, a given type of tally mark, and/or some other counting indicator. Further, the win meter 62 may immediately increment an amount corresponding to the winning combination of selected and submitted cards as specified by the primary payout section 52A of the pay table 52.

Other secondary payouts 52B-D may also cause entries of the pay table 52 to increment, in addition to the win meter 62. For example, the secondary payout entry field 52B labeled EACH FULL SUIT may increment each time all the cards of any particular suit of cards are played in winning combinations. That is, if all of the cards of a particular suit have been played via winning combinations during any single instance of the wagering game, the player receives a payout 52B associated with the each-full-suit award which is typically accounted in the win meter 62. Similarly, the secondary payout entry field 52C labeled FOUR ACES may increment after all four aces of the deck are played in any combination of winning combinations, causing a suitable increase in win meter 62 in accordance with the pay table 52. Another example includes secondary payout entry field 52D labeled EXPOSE TABLEAU which increments when all the face-down cards of tableau 54 are exposed, that is, all the hidden cards of tableau 54 (stacks 54A-54E) are turned face-up, leaving no tableau cards remaining face-down, and increasing the win meter 62 accordingly. Yet another example includes incrementing a secondary payout entry field labeled TABLEAU STACK REVEALED (not shown) when one of the tableau stacks 54A-E has no remaining hidden cards under the top, exposed card.

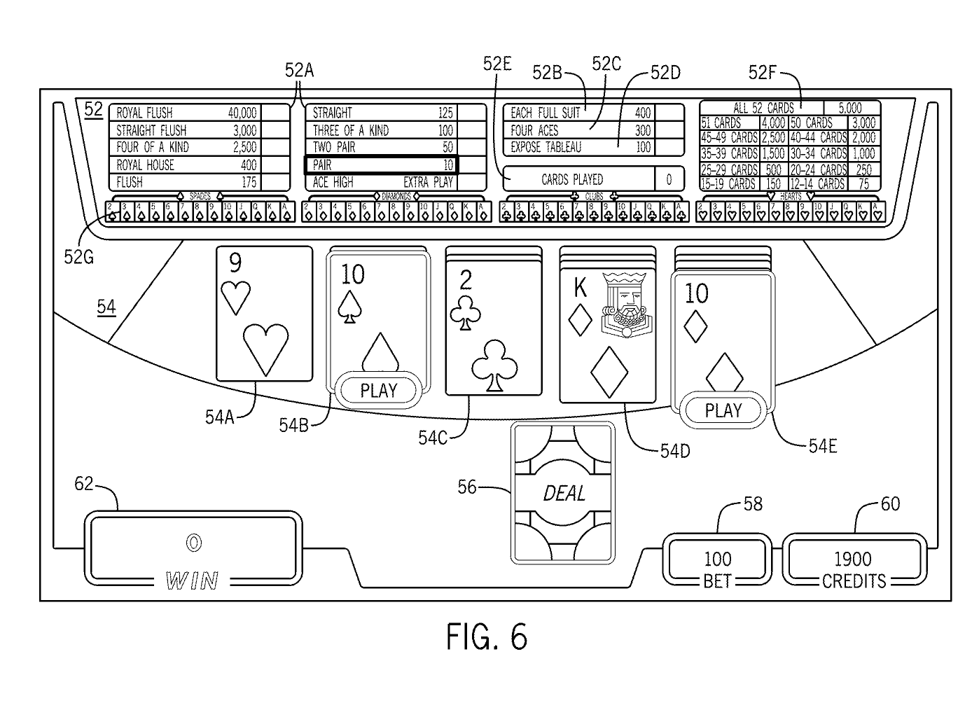

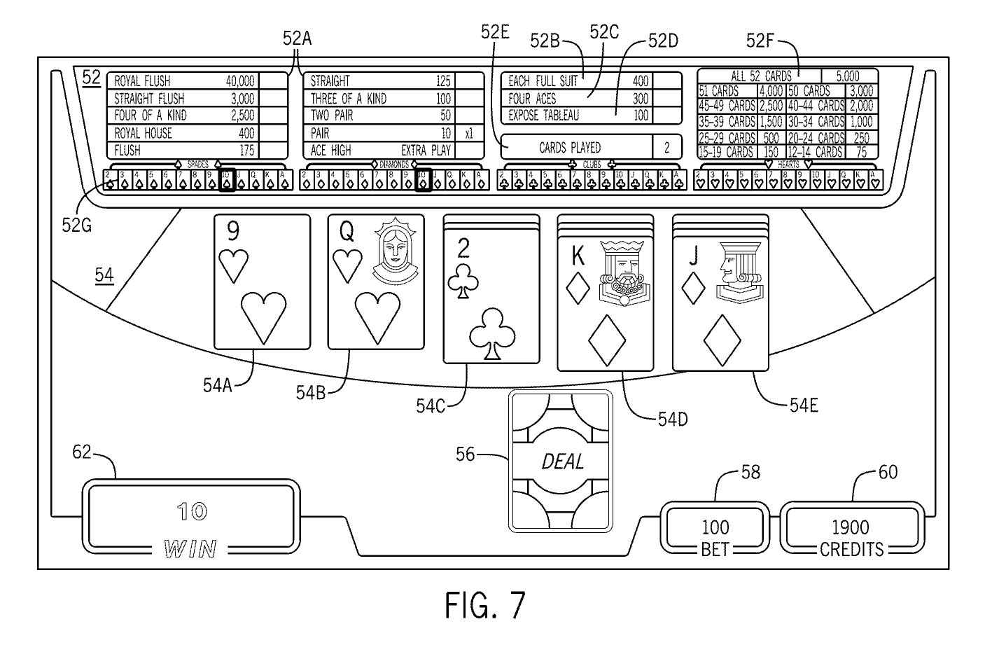

According to one embodiment, exposed cards which appear as part of the tableau 54 (and optionally, the top card of the stock pile 56, detailed below) are used to specify sets of cards which match particular winning combinations of cards specified in the pay table 52. During game play, cards are selected by a player to construct winning combinations of cards corresponding to entries in the primary payout section 52A of the pay table 52. After selection of a winning combination of cards, the player finalizes the selection of the winning combination of cards by submitting the cards as part of the specified winning combination of cards. Player interaction typically happens using a graphical user interface (for example, selecting the winning combination of cards from the tableau 54 using a cursor or touch screen), and the card(s) are submitted by activation of a highlighted button. Alternatively, an electronic gaming machine having one or more physical buttons may be used to move a cursor and select cards for play and submission. FIG. 3 shows no highlighted button for card submission since no card(s) have been selected to construct a winning combination, however, once a winning combination of cards is selected, a selectable button may appear similar to the highlighted stock pile as displayed in FIGS. 6 and 7.

Once the winning combination of card(s) is selected and submitted, the cards are considered played and are removed from play. The played cards are replaced with remaining cards from the deck which are currently hidden. For example, when cards atop one or more of the tableau stacks 54A-54E form part of a winning poker hand combination specified in the primary payout region 52A of the pay table 52, the winning card(s) are removed from atop the respective tableau stack(s) 54A-54E. These cards may be replaced by exposing a subsequent face-down card of the appropriate tableau stack 54A-54E, if such a face-down card exists. In one embodiment, when no face-down card exists in the appropriate tableau stack 54A-54E, another card is exposed and placed upon the appropriate tableau stack 54A-54E from which the winning card was removed. This card may come from a stock pile 56 or another tableau stack 54A-54E. As cards are played after forming a winning combination corresponding to the primary payout entries 52A, played cards are individually specified (e.g., highlighted or illuminated) in the list of representative cards 52G, and the card meter 52E is incremented for each played card.

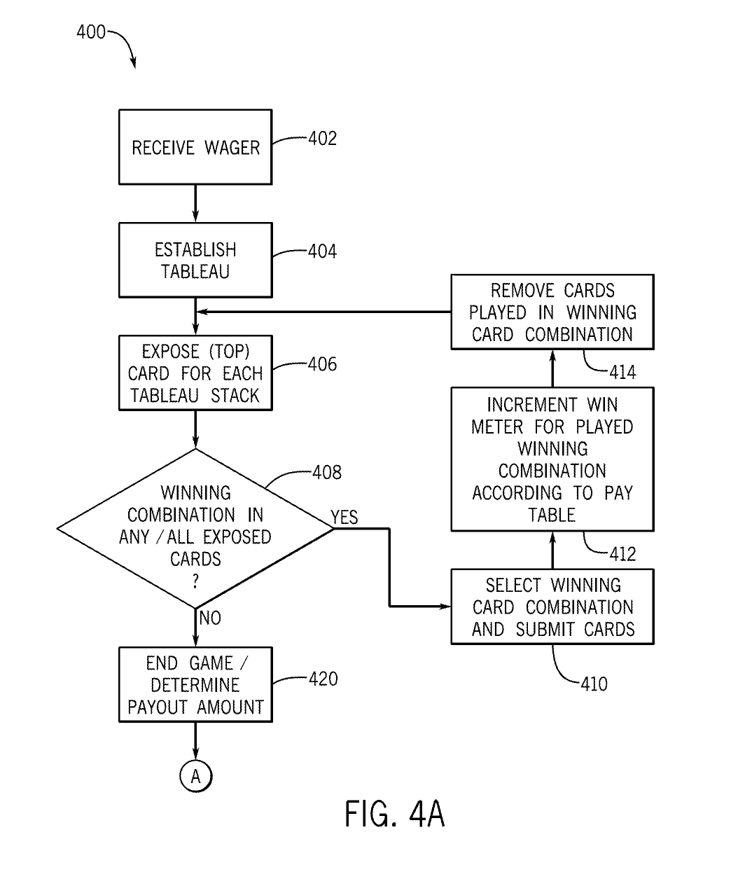

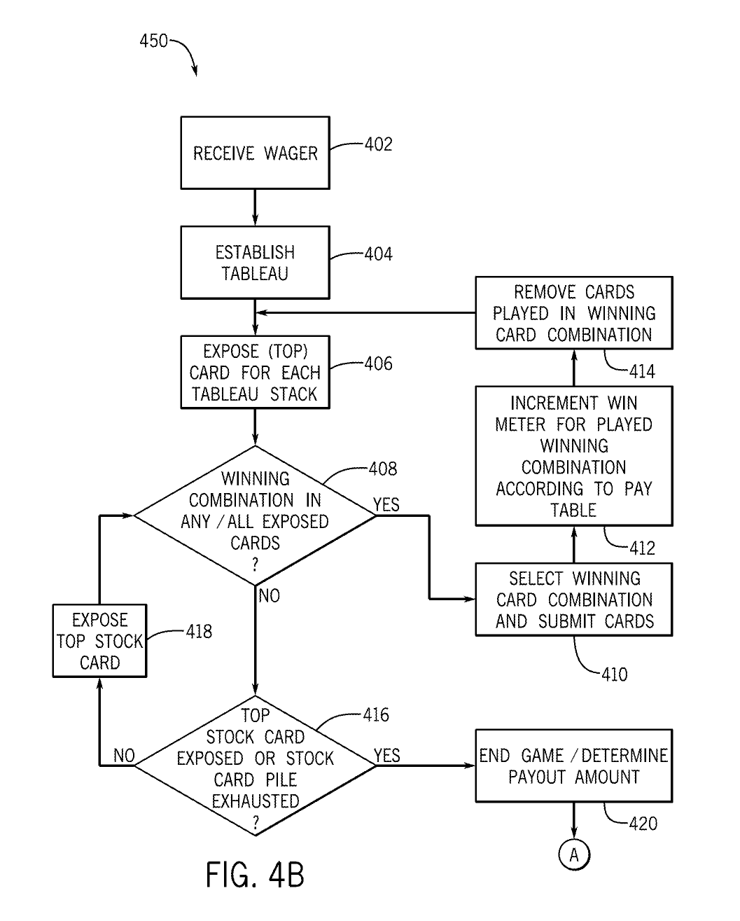

According to one embodiment, a winning combination of cards is played and the played cards from the tableau stacks are replaced as long as there are hidden cards remaining in the tableau stack(s) or there are remaining cards remaining in the stock pile. This process is repeated until no more remaining winning combinations specified in the primary payout section 52A of pay table 52 can be made from the entirety of exposed cards, and the game terminates. The overall process of this embodiment is discussed in more detail below in regard to FIG. 4A.

According to one embodiment, a winning combination of cards is played and the played cards from the tableau stacks are replaced as long as there are hidden cards remaining in the tableau stack(s) or there are remaining cards remaining in the stock pile. Additionally, when no combination of exposed cards in the tableau stacks may be selected which match a winning combination of cards specified in the payout table (e.g., primary payout section 52A of pay table 52), one or more additional cards are exposed (i.e., revealed) from the stock pile, and formulation of a winning combination may continue via selection, submission, and removal from play, etc. This process is repeated until there are no winning combinations specified in the pay table from the entirety of all exposed cards, and the game terminates. This embodiment is discussed in more detail below in regard to FIG. 4B.

FIG. 4A and 4B represent algorithms which correspond to at least some instructions stored and executed by the game-logic circuitry 28 in FIG. 2 that perform the above described functions associated with the disclosed concepts.

Referring to FIG. 4A, a flow chart is used to detail the process of playing the game and calculating payouts in accordance with one embodiment. The algorithm 400 begins with receiving a wager at step 402, which causes initiation of the game. Initiation of the game may involve a variety of functions, including resetting all appropriate variables to an initial state (e.g., zero), generation of imagery for the primary display area 12, random number generation, deck/card determinations, etc.

In step 404, the tableau (e.g., tableau 54) is generated and displayed, including the contents and graphical form of the hidden cards for each of the tableau stacks. In differing embodiments, the tableau may consist of differing number of tableau stacks (e.g., seven, or five as shown in FIG. 3) having a differing number of hidden cards in each tableau stack (e.g., five in each tableau stack, or an ascending number of hidden cards in each tableau stack as shown in FIG. 3). After all the hidden cards of the tableau have been determined, the top card of each tableau stack is exposed at step 406.

In step 408, a determination is made about the presence of a winning combination of cards as specified in the pay table (e.g., primary payout section 52A) which can be formed from the set of exposed cards. In this instance, the set of exposed cards includes only the cards exposed atop the tableau stacks (e.g., FIG. 3. tableau stacks 54A-54E).

In step 410, in response to there being a combination of exposed cards which may be selected to match a winning combination specified in the pay table, the player is prompted to select a set of the exposed cards which match the winning combination specified in the pay table. The player selects a set of the exposed cards which match a winning combination specified in the pay table, and the player submits the selection. This submission may involve actuation of a physical button after card selection or selection of a highlighted button on a touch display labeled “submit,” “play,” or “deal” (e.g., see FIG. 6). Alternatively, where only one winning hand is possible, the selection may be automatically displayed. Similarly, in some embodiments, where multiple winning hands are possible, the preferred hand, or the hand having the highest value, may be automatically displayed as pre-selected. In this embodiment, the player may still be provided with the opportunity to select one of the other potential winning hands prior to submission.

In step 412, once a winning card combination is played (i.e., selected and submitted), a win meter is incremented with the appropriate amount corresponding to the selected winning combination of cards submitted by the player, based on the one or more payouts specified in the pay table.

In step 414, the played cards are removed from play. In one embodiment, played cards are specifically indicated on a visual display for the player (e.g., representative cards 52G). Any suitable animation or other graphical presentation of card removal may be provided to the player and observers without departing from the spirit and scope of the present invention.

After played cards are removed from play, flow control returns to step 406, where the top card of each tableau stack is exposed. In the event that a given tableau stack has no hidden cards to expose, a card is chosen from the remaining cards of the deck (e.g., stock pile 56), the card is revealed, and is placed on the corresponding tableau stack. After exposure of the top cards of each tableau stack, operation then returns to step 408, and a determination of whether a combination of cards can be formed to match a winning combination of cards specified in the pay table from the exposed cards in the tableau is repeated.

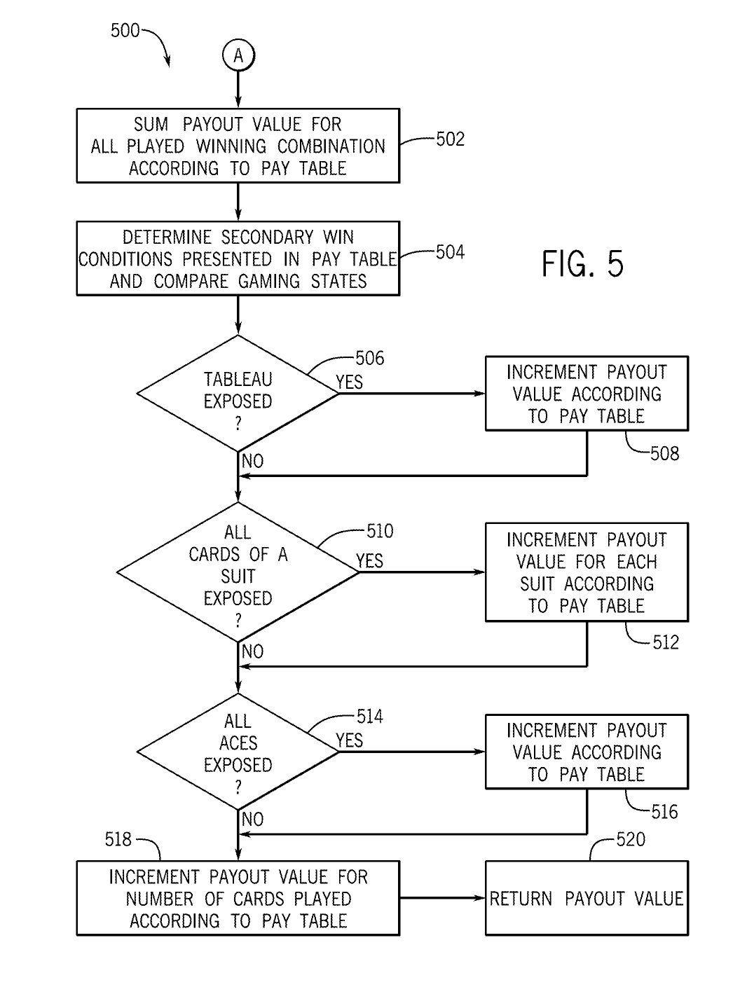

In the event that no winning combination of cards specified in the pay table may be made from the exposed cards exposed of the tableau, the game ends (step 420) and a total payout is determined according to the achievements made during the game. The determination of the total payout is more fully detailed with respect to FIG. 5.

Referring to FIG. 4B, a flow chart is used to detail the process of playing the game and calculating payouts in accordance with another embodiment. The embodiment set forth in FIG. 4B differs from the embodiment set forth in FIG. 4A in that cards from the stock pile become available to create winning combinations according to the pay table 52 when no winning combinations can be formed by cards in the exposed cards of tableau 54. In FIG. 4A, the game would end when no winning combination can be formed by all the exposed cards of tableau 54, and the embodiment illustrated in FIG. 4B describes that when this occurs, an additional card is exposed from the stock pile and becomes part of the set of exposed cards to create winning hands. However, in the event that the exposed card from the stock pile fails to create a winning combination, the game ends and the appropriate payout for prior winning combinations and secondary achievements are awarded to the player.

FIG. 4A and FIG. 4B share similar functional behavior in many of the shared algorithmic steps, and the full details regarding identical steps will not be repeated for the sake of brevity. Any variations and equivalencies which do not depart from the spirit and scope of the invention applicable to algorithm 400 are likewise applicable to algorithm 450.

Algorithm 450 begins with receiving a wager at step 402, which causes initiation of the game. A tableau (e.g., tableau 54) is generated and displayed at step 404, including the contents and graphical form of the hidden cards for each of the tableau stacks. After all the hidden cards of the tableau have been determined and displayed, the top card of each tableau stack is exposed at step 406 and a determination is made at step 408 whether a winning combination of cards is present as specified in the pay table (e.g., primary payout section 52A). The winning combination of cards can be formed from combinations of one or more of the set of exposed cards. If there is a combination of exposed cards that may be selected to match a winning combination specified in the pay table, the player is prompted to select a set of the exposed cards which match the winning combination specified in the pay table. The player selects a set of the exposed cards which match a winning combination specified in the pay table, and then submits the selected cards at step 410. Once a winning card combination is played (i.e., selected and submitted), a win meter is incremented at step 412 by the appropriate amount based on one or more payouts specified in the pay table, the payouts corresponding to the selected winning combination of cards selected by the player. The played cards are then removed from play at step 414 and flow control returns to step 406, where the top card of each tableau stack is again exposed or revealed from a stock pile (e.g., stock pile 56) in accordance with the description above in regard to FIG. 4A.

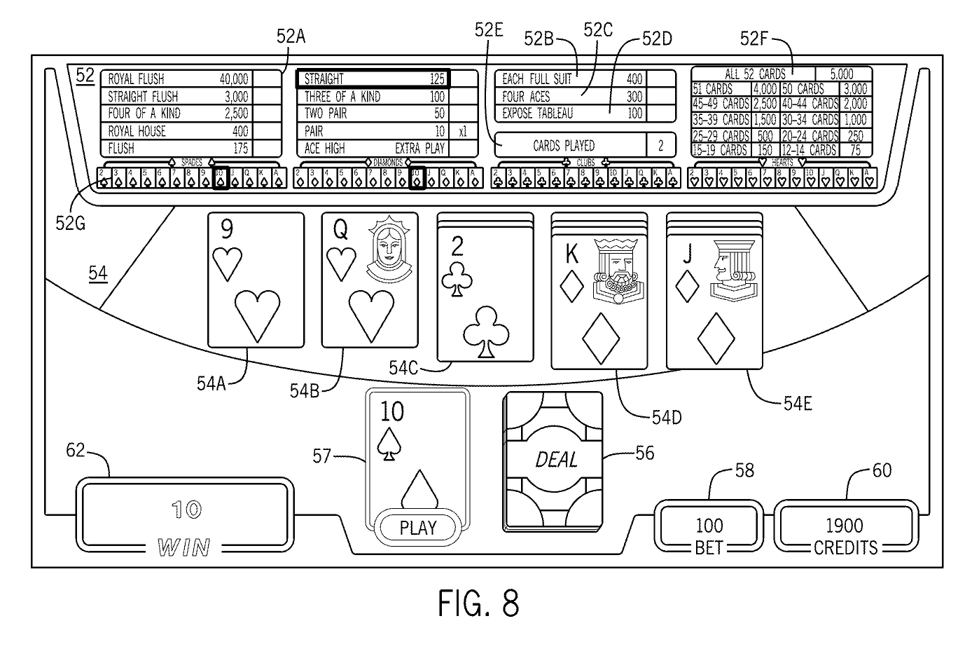

However, when no winning combination of cards specified in the pay table can be made from all the exposed cards in the tableau at step 408, a determination is made at step 416 as to whether a top stock card is exposed or there are no remaining hidden stock pile cards which can be exposed. If the top card (i.e., top stock pile card 57 as seen in FIG. 8) of the stock pile (i.e., stock pile 56) is not exposed and there are cards remaining in the stock pile that are eligible to be exposed, the top stock card is exposed and revealed to the player at step 418. That is, if no winning combinations can be made from the set of exposed cards present in the tableau, the top card of the stock pile is exposed in addition to the other exposed cards and is added to the tableau.

After exposing the top card of the stock pile, flow returns to step 408, where a new determination is made about the presence of a winning combination of cards which can be formed from the set of exposed cards of the tableau, which now includes the newly exposed stock card (e.g., top stock pile card 57).

When there exists a set of exposed cards which match a winning combination of cards specified in the pay table, the winning combination of cards are selected and submitted by the player at step 410, as before, a win meter is incremented accordingly at step 412, and the played cards are removed from play at step 414, populating the tableau with a new set of exposed cards (if available) at step 406.

In the event that no winning combination of cards specified in the pay table may be made from the exposed cards of the tableau, the game ends at step 420 and a total payout is determined according to the achievements made during the game to compensate the player for the initial wager. One algorithm that may be utilized for determining the total payout is detailed in FIG. 5.

It is noted that algorithm 450 is not limited to exposing a single card from the stock pile and adding it to the tableau when no winning combination exists. Any number of cards may be revealed from the stock pile (or tableau stacks) to increase the number of exposed cards available to the player to create winning combinations in accordance with the invention without departing from the spirit and scope of the invention.

In both FIGS. 4A and 4B, after game play ends, all accounting is completed and credit transfer is performed, and the gaming machine (e.g., gaming machine 10) may enter any one of various programmed modes including an attraction mode to attract another player or promote further play. Alternatively, an entertainment mode to provide video and/or audio information may be engaged. Any operation of the gaming machine during periods of non-game play are completely arbitrary and do not depart from the spirit and scope of the present invention in any fashion.

Referring to FIG. 5, the total payout for a completed game is determined in process 500. In step 502, all the winning combinations of the pay table which were selected and submitted by the player during game play are all tallied, including multiple instances of the same winning combinations. That is, a payout value for the sum of all the played winning combinations during the game is determined in accordance with the pay table is determined. This may include use of a win meter (e.g., win meter 62), which is actively incremented each time a winning combination is played during the game. The total payout value for all the winning combinations played during the game is determined by the associated payouts for each of the winning combinations (e.g., as specified in the primary payout section 52A), multiplied by an incremented value for each of the winning combinations.

In step 504, when the game terminates, game states are compared to the secondary conditions specified in the pay table (e.g., secondary conditions 52B-52E) after all the submitted winning combinations are tallied. These game states may include variables which are incremented as gameplay progresses, or reflect a final result of the exposed, played, or hidden cards when gameplay ends. Each of the secondary conditions, if any, are tallied to increase the total payout earned during gameplay. In the current embodiment, step 504 includes the secondary conditions 52B-52E in the pay table 52 as shown in FIG. 3. The component portions of step 504 are detailed in steps 506-518. Any set of secondary conditions may be compared against the state of game variables when gameplay ends without departing from the spirit and scope of the invention.

In this embodiment, the process of tallying secondary conditions begins with step 506, where a determination is made as to whether all the hidden cards of the tableau (e.g., tableau 54) were exposed during game play. If so, the appropriate credit reward is added to the payout total at step 508, and if not, no adjustment of the payout total is made. The next secondary condition is examined; a determination is made at step 510 as to whether each card rank of each individual suit was played during game play. If so, step 512 is performed to increment an appropriate credit amount to the payout tally shown on a win meter (e.g., win meter 62) for each suit having all ranked cards played during the game. Another secondary condition is now examined; it is determined at step 514 whether all four aces were played during game play. If so, step 516 is performed which increments the payout total by the appropriate amount.

Remaining with the pay table displayed in FIG. 3, a final secondary condition is determined, based upon the number of cards played during game play; a bonus corresponding to the total number of cards played during game play is accounted and added to the payout total at step 518. In the current embodiment shown in FIG. 3, the bonus specified by the associated payout 52F for the value of card meter 52E is added to the payout total. It is noted that any arbitrary level of award values for any arbitrary set ranges of played cards may be specified without departing from the spirit and scope of the present invention.

After all secondary win conditions are accounted for, a total payout value is awarded at step 520, which is typically immediately incremented to the win meter (e.g., player's win meter 62), and the contents of the win meter is subsequently transferred to a player credit meter (e.g. credit meter 60) to complete the game.

Referring now to FIGS. 3 and 6-9, one game-play embodiment utilizing the features and associated mechanics of the present invention is illustrated. Referring to FIG. 3, a wager is made and is reflected in wager meter 58. This may be performed by a player using an input device to specify how many credits are being waged, or may be automatically assigned or designated. In the current embodiment, a wager of one hundred credits is indicated by wager meter 58. When the game begins, the amount of the wager displayed in the wager meter 58 is deducted from the credit meter 60 shown on the main player display (e.g., display 12) when the game begins.

In this embodiment, the tableau 54 is created by displaying five distinct tableau stacks 54A-54E, where each stack has an increasing number of face-down hidden cards. When the game begins, the top card of each tableau stack is exposed, i.e., turned face-up and revealed. The cards of the stock pile 56 remain inactive until called upon to replace a played card atop a tableau stack having no additional hidden cards, or until no combination of exposed cards in the tableau 54 can be selected to match a winning combination as specified in the primary payout section 52A of the pay table 52.

In this embodiment, the cards exposed on tableau stacks 54B and 54E are of equal rank (both are ranked “ten”), and can be combined to match the winning PAIR combination (shown highlighted in FIG. 3 and FIG. 6) in the primary payout section 52A. In the event that 54A, 54B, 54C, and 54D all had cards ranked identically (e.g., the first four tableau stacks each have an exposed “ten” on top), FOUR OR A KIND, THREE OF A KIND, and PAIR, would all be highlighted; any of these winning combinations may be chosen and selected from the exposed cards available to the player in the tableau 54 of this example to create a winning combination specified in the primary payout section 52A. In a further example, if tableau stacks 54A, 54B, and 54C, all had cards ranked identically (e.g., the first three tableau stacks each have an exposed “ten” on top), and tableau stacks 54D and 54E are also identical (e.g., the last two tableau stacks each have an exposed “three” on top), FULL HOUSE, THREE OF A KIND, TWO PAIR, and PAIR, would all be highlighted as possible selectable winning combinations.

Returning to FIG. 6, the cards atop tableau stacks 54B and 54E must be selected to match a winning combination of cards as specified in the primary payout section 52A to continue game play as shown in FIG. 6. This is because the cards atop the tableau stacks 54B and 54E are the only possible winning combination of all of the currently exposed cards. After player selection, the word “PLAY” is shown on each of the selected cards to indicate which cards upon which stacks are selected for submission.

Any visual and/or audio indication of specific card/stack selection may be equivalently used which indicates to the player (and the game) which exposed card(s) are selected (or are capable of selection) to match a specified winning combination in the primary payout section 52A of the pay table 52. A wide variety of different display options are possible without departing from the spirit and scope of the present invention, including no indication at all, flashing borders, audio/verbal indications, etc.

After sufficient cards have been selected to specify a particular winning combination specified in the primary payout section 52A of the pay table 52, the stock pile 56 is highlighted to indicate the selected cards are eligible to be used for the winning combination. Upon player actuation of the highlighted DEAL shown on stock pile 56 to submit the cards, the cards become “played”, and resultantly, the cards are removed from play and the appropriate winning combination in the primary payout section 52A of the pay table 52 matching the selected cards is incremented (along with the win meter 62).

The played cards are replaced in the tableau 54 with new, exposed cards from the corresponding tableau stacks 54A-54E when there is an available hidden card in the corresponding tableau stack 54A-54E to expose. In the event that there is no available hidden card to expose in a given tableau stack 54A-54E and there are cards remaining in the stock pile 56, a card is exposed from the stock pile 56 and placed on the appropriate tableau stack 54A-54E. When no cards remain in the stock pile 56 and no hidden cards remain in a given tableau stack 54A-54E, no card is exposed for that particular tableau stack 54A-54E. Thus, when the number of hidden cards in the stock pile 56 and the various tableau stacks 54A-54E decrease, the number of exposed cards available to create winning combinations of the primary payout section 52A of the pay table 52 may also decrease.

Referring now to FIG. 7, after the cards on tableau stacks 54B and 54E are played as a winning combinations of the primary payout section 52A of the pay table 52 (i.e., PAIR), tableau stack 54B has no remaining hidden cards in the stack and the number of hidden cards in tableau stack 54E decreases from four to three. The PAIR entry winning combination in primary payout section 52A is correspondingly incremented (i.e., “x1” specifying one PAIR has been played in total), the number of cards played increments the card meter 52E accordingly (one for each played card of the combination), and the played cards are highlighted in the list of representative cards 52G (i.e., ten of spades and ten of diamonds). The win meter 62 is also incremented by the amount corresponding to the selected winning combination of the primary payout section 52A of the pay table 52 (i.e., 10 credits). When this processing completes, all played cards are replaced with new exposed cards (as noted above), and control of the game returns to a state where a determination is made as to whether a winning combination of the primary payout section 52A of the pay table 52 exists in the exposed cards of tableau 54.

In FIG. 7, it can be seen that no set of exposed cards exposed in tableau 54 can be arranged to match a winning combination of the primary payout section 52A of the pay table 52. Thus, the player is forced to select stock pile 56 (in order to continue playing the game), thereby exposing an additional card (the top card of the stock pile 56) which joins the exposed cards of the tableau and becomes eligible for use in creating a winning combination of the primary payout section 52A of the pay table 52. The result of this selection and card exposure is shown in FIG. 8.

Referring now to FIG. 8, the top card of stock pile 56 is turned face-up to expose top stock pile card 57. Another determination is made as to whether a winning combination of the primary payout section 52A of the pay table 52 exists in the exposed cards of tableau 54 which now includes the top stock pile card 57. Since a combination is now present, the player is given another opportunity to select a set of cards from all the exposed cards of the tableau (exposed cards atop tableau stacks 54A-54E and exposed top stock pile card 57) to create a winning combination of the primary payout section 52A of the pay table 52. In the current case, exposed top stock card 57 enables the player to complete a straight using five consecutively ranked cards; this corresponds to the winning combination “STRAIGHT” of the primary payout section 52A of the pay table 52; the winning combination “STRAIGHT” entry is highlighted in the primary payout section 52A to indicate that some set of the exposed cards match a winning combination of the primary payout section 52A of the pay table 52.

The player is prompted to select exposed cards from the tableau 54 to create a winning combination of the primary payout section 52A of the pay table 52, and after the player has selected all the cards of the straight (i.e., nine through king on tableau stacks 54A, 54B, 54D, 54E, and exposed top stock card 57), selection of the “DEAL” icon (i.e., stock pile 56) will cause the selected cards to be submitted (i.e., played). This causes all the selected cards of the winning combination of the primary payout section 52A of the pay table 52 to be removed from play. The STRAIGHT winning combination counter in the primary payout section 52A is incremented accordingly, and the card meter 52E is incremented by five (one for each played card). The win meter 62 is also incremented by the amount specified by the primary payout section 52A of the pay table 52 (i.e., 125 credits).

Play of the game continues in this fashion, displaying exposed cards in tableau 54 atop each of the tableau stacks 54A-54E, combining cards from tableau 54 to create a winning combination of cards specified in the primary payout section 52A of the pay table 52, and replacing the cards in the tableau 54 from hidden cards in the appropriate tableau stack 54A-54E or stock pile 56 (as long as cards remain in the stock pile 56). This cycle of game play continues until no winning combination of the primary payout section 52A of the pay table 52 can be formed from the cards in tableau 54, and exposed top stock card 57 is revealed, at which point, the game ends and a final tally of payout according to all sections of the pay table 52 is performed.

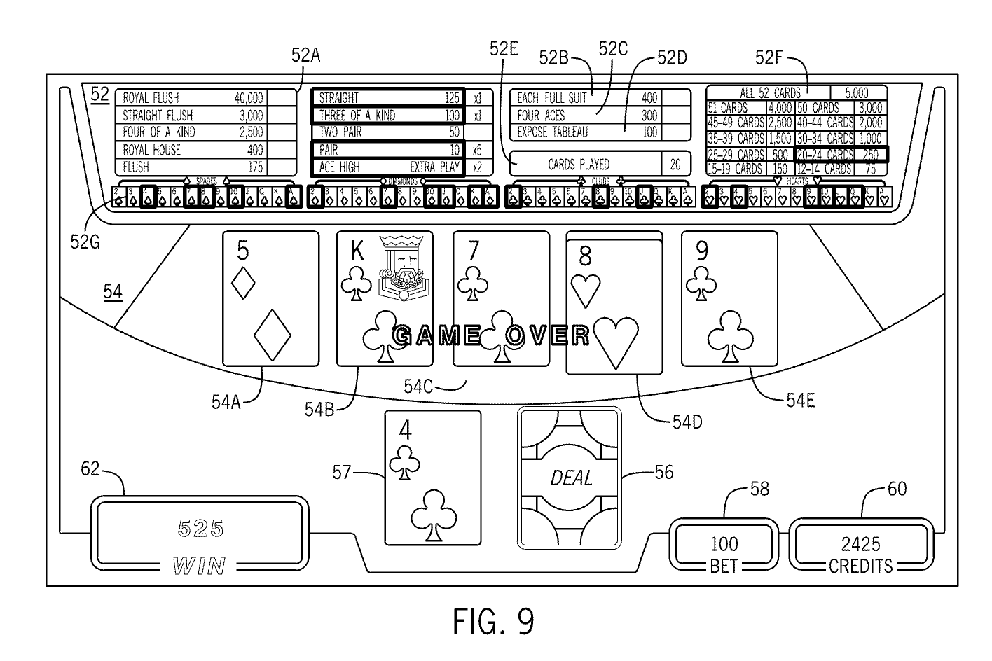

Referring now to FIG. 9, the player has continued to submit winning combinations of cards specified in primary payout section 52A of the pay table 52 which include a STRAIGHT, THREE OF A KIND, five PAIR, and two ACE HIGH combinations. The cards exposed in tableau 54, including exposed top stock card 57, cannot be combined to form a winning combination from the primary payout section 52A of the pay table 52. It can be seen that the player has played a total of twenty cards (shown in card meter 52F), and each individually played card is specifically indicated in the highlighted section of the list of representative cards 52G.

An additional bonus is specified in the pay table 52 corresponding to a set of secondary conditions which includes the value of card meter 52F. In this case, the player played twenty total cards, so an additional bonus of two-hundred-fifty credits is incremented to the win meter 62.

By way of example, if the exposed top stock pile card 57 was a six of clubs (as opposed to the four of clubs, as shown), the player would be able to select and play the cards of tableau stacks 54A, 54C, 54D, 54E, and exposed top stock pile card 57 to play an additional STRAIGHT. The selection of this winning combination of the primary payout section 52A of the pay table 52 would additionally expose the last of the hidden tableau cards, currently present only in tableau stack 54D. The result of playing this winning combination of cards would increment the STRAIGHT field entry in the primary payout section 52A of the pay table 52, increment the card meter 52E by five (one for each played card), increment the EXPOSE TABLEAU entry field 52D, and increment the win meter 62 accordingly. Thus, win meter 62 would increase an additional one-hundred-twenty-five credits (for the STRAIGHT), two-hundred-fifty credits (for the additional number of cards played), and one-hundred credits (for exposing all the cards of the tableau). Once the selected cards are played, the played cards are removed from play, new exposed cards are replaced on tableau stacks 54A, 54C, 54D, 54E from stock pile 56, and game play continues until no winning combinations of the primary payout section 52A of the pay table 52 can be made from all combinations of exposed cards.

When performing the process of FIG. 5 in regard to the current game state shown in FIG. 9, a single STRAIGHT (125 credits), a single THREE OF A KIND (100 credits), and five distinct PAIR (at 100 credits each) are all tallied to determine payout in step 502. The primary payout section 52A of the pay table 52 specifies that the two ACE HIGH combinations do not alter the payout tally, since these combinations provide the player with another draw from the appropriate tableau stack 54A-54E or top stock pile card 57, and award no credits as a result. Alternatively, a payout may be specified for a single card winning combination (like ACE HIGH) rather than an extra draw or additional card.

A number of different aspects may be included as alternatives to, or in addition to, the above embodiments as specified; an artisan would recognize a multitude of variations which stem directly from the above description which do not depart from the spirit and scope of the present invention.

For example, a typical video poker game is executed with a single, standard 52-card deck (i.e., Ace through King of four different suits). However, it is known to modify a standard 52-card deck by supplementing with additional bonus cards such as value cards, wild cards, etc. Thus, the disclosed video poker game may be played with a single deck (or any number of decks) of cards, having standardized (or a variety of different) card compositions and presentations, with a varying number of tableau stacks and layouts, while providing multiple additional exposed cards (or none at all), all without departing from the intended spirit and scope of the present invention.

As an example, other embodiments may include no stock pile provided at all, where the tableau comprises thirteen tableau stacks each having an exposed card atop three hidden cards. Similarly, the number and structure of the tableau stack(s) may be of any type, including a single tableau stack with a number of stock pile cards exposed, or seven tableau stacks and a stock pile which may or may not contain all the remaining cards not currently exposed.

In another embodiment, when there are insufficient cards of a corresponding tableau stack and/or the stock pile to replace played cards, tableau stacks may remain vacant, no longer presenting an exposed card available for combination with other exposed cards to make winning combinations.

Further, more than a single card may be exposed from the stock pile in the event there is no winning combination of cards specified in the pay table which can be made from all the exposed cards in the tableau. For example, one embodiment may expose three cards from the stock pile when no winning combination can be formed from the exposed cards of the tableau, and the cards remain available for future combinations. In another embodiment, the exposed stock pile cards may or may not be automatically replaced after a winning combination is formed. Alternatively, any unused cards may be simply removed from play and discarded after a winning combination is formed.

As can be recognized by a skilled artisan, any configuration of a primary payout section of the pay table may be realized without departing from the spirit and scope of the present invention. One embodiment may dictate that four cards are required for any winning combinations specified in the pay table, and another embodiment may include a minimum of three cards used, or “Jack or better” to form winning card pairs.

Another embodiment may include winning combinations of the pay table which include playing the single lowest card for each suit which are currently not played. For example, an ace of each suit may be a winning combination, and once the ace of a given suit is played (e.g., ace of hearts), the next highest rank of that given suit (i.e., the “two” of hearts) becomes a winning combination. After the “two” of hearts is played, the “three” of hearts becomes a winning combination, etc. Another embodiment may include mandatory use of the lowest card for each suit not currently played in any selected and submitted winning combination of cards without departing from the overall spirit and scope of the invention.

In another embodiment, a variety of additional secondary bonuses may be implemented, including a bonus for exposure of all the cards in a single tableau stack. Another embodiment may include a bonus or a total payout to be awarded to the player as a secondary condition, purely for the number of played cards. Another embodiment may include a bonus awarded for the exhaustion of the stock pile, or the successful playing of a minimum number of cards of the stock pile. Another embodiment may include a bonus awarded when all the cards of a given suit are played. Another embodiment may include awarding a bonus for the exposure of all hidden cards in a particular tableau stack. Another embodiment may include awarding a bonus proportional to the number of hidden cards in a tableau stack when all the hidden cards of that particular tableau stack are exposed.

The details and specifics of the above examples, including the types and value of specific payouts, sets of cards dictating winning combinations, type and value of fulfilled game conditions, and bonus based on the number of played cards are arbitrary and discretionary, and are able to be modified or omitted without departing from the spirit and scope of the present invention.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming system comprising:
one or more input devices;
one or more display devices;
game-logic circuitry, comprising one or more central processing units and one or more memory devices, the one or more memory devices storing instructions that, when executed by the one or more central processing units in response to an input indicative of a wager, cause the game-logic circuitry to:
display, via at least one of the one or more display devices, a tableau comprising a plurality of tableau stacks each having an exposed top card atop zero or more hidden cards; and
determine whether any combination of all exposed cards matches a winning combination comprising at least one exposed card specified in a pay table, and in response to a winning combination being exposed,
receive, via at least one of the one or more input devices, a selection of the exposed cards to be played to form the winning combination,
remove the selected cards from play,
increment a win meter with a primary payout value corresponding to the winning combination, and
replace the selected cards by selectively exposing cards from each of the corresponding plurality of tableau stacks or a card stock-pile comprising the remaining cards that are not a part of the plurality of tableau stacks.

2. The gaming system of claim 1, wherein the instructions further cause the game-logic circuitry to expose at least one stock-pile card when no combination of exposed cards from the tableau stacks matches any winning combination specified in the pay table.

3. The gaming system of claim 2, wherein the instructions further cause the game-logic circuitry to terminate the game when no combination of all exposed cards, including the at least one stock-pile card, matches any winning combination specified in the pay table.

4. The gaming system of claim 1, wherein the instructions further cause the game-logic circuitry to:
replace the selected cards of each of the corresponding plurality of tableau stacks by exposing a hidden card from the corresponding tableau stack, in response to one or more hidden cards being present in the corresponding tableau stack; and
replace the selected cards of the corresponding plurality of tableau stacks with a stock-pile card when no hidden cards are present in the corresponding tableau stack.

5. The gaming system of claim 1, wherein the instructions further cause the game-logic circuitry to increment the win meter by a payout value corresponding to the number of replaced cards.

6. The gaming system of claim 1, wherein the instructions further cause the game-logic circuitry to increment the win meter by a payout value when all the hidden cards of at least one of the plurality of tableau stacks are exposed.

7. The gaming system of claim 1, wherein the instructions further cause the game-logic circuitry to increment the win meter by a payout value when all the hidden cards of the plurality of tableau stacks are exposed.

8. The gaming system of claim 1, wherein the instructions further cause the game-logic circuitry to increment the win meter by a payout value when all the cards of a particular suit are replaced.

9. The gaming system of claim 1, wherein the instructions further cause the game-logic circuitry to increment the win meter by a payout value when all the cards of a particular rank are replaced.

10. A computer-implemented method in a gaming system having game-logic circuitry including one or more central processing units and one or more memory devices, the method comprising:
receiving, via at least one of one or more input devices, an input indicative of a wager, and in response:
displaying, on at least one of one or more display devices, a tableau comprising a plurality of tableau stacks each having an exposed top card atop zero or more hidden cards; and
determining, by the game-logic circuitry, whether any combination of all exposed cards matches a winning combination comprising at least one exposed card specified in a pay table, and in response to a winning combination being exposed,
receive, via at least one of the one or more input devices, a selection of the exposed cards to be played to form the winning combination,
remove the selected cards from play,
increment a win meter with a primary payout value corresponding to the winning combination, and
replace the selected cards by selectively exposing cards from each of the corresponding plurality of tableau stacks or a card stock-pile comprising the remaining cards that are not part of the plurality of tableau stacks.

11. The computer-implemented method of claim 10, further comprising instructions causing the game-logic circuitry to expose at least one stock-pile card when no combination of exposed from the tableau stacks matches any winning combination specified in the pay table.

12. The computer-implemented method of claim 11, further comprising instructions causing the game-logic circuitry to terminate the game when no combination of all exposed cards, including the at least one stock-pile card, matches any winning combination specified in the pay table.

13. The computer-implemented method of claim 10, further comprising instructions causing the game-logic circuitry to increment the win meter by a payout value corresponding to the number of replaced cards.

14. The computer-implemented method of claim 10, further comprising instructions causing the game-logic circuitry to increment the win meter by a payout value when all the hidden cards of at least one of the plurality of tableau stacks are exposed.

15. The computer-implemented method of claim 10, further comprising instructions causing the game-logic circuitry to increment the win meter by a payout value when all the hidden cards of the plurality of tableau stacks are exposed.

16. The computer-implemented method of claim 10, further comprising instructions causing the game-logic circuitry to increment the win meter by a payout value when all the cards of a particular suit are replaced.

17. The computer-implemented method of claim 10, further comprising instructions causing the game-logic circuitry to increment the win meter by a payout value when all the cards of a particular rank are replaced.

18. A computer-implemented method in a gaming system having game-logic circuitry including one or more central processing units and one or more memory devices, the method comprising:
receiving, via at least one of one or more input devices, an input indicative of a wager;
displaying, on at least one of one or more display devices, a plurality of tableau stacks each having an exposed card;
selecting one or more of the exposed cards to form a winning combination;
replacing the selected cards by selectively exposing cards from the plurality of tableau stacks or a card stock-pile comprising the remaining cards that are not a part of the plurality of tableau stacks; and
providing an award when all the cards of a particular suit are replaced.

19. The computer-implemented method of claim 18, wherein replacing the selected cards includes exposing a hidden card for a corresponding tableau stack in response to at least one hidden card being present in the corresponding tableau stack, else exposing a card of the stock-pile for the corresponding tableau stack in response to no hidden cards being present in the corresponding tableau stack.

20. The computer-implemented method of claim 18, further comprising instructions causing the game-logic circuitry to expose a stock-pile card in response to no winning combination specified in the pay table being present in the exposed cards, and terminate the game in response to no winning combination specified in the pay table being present in the exposed cards and the stock-pile card.
